(19) United States
(12) Patent Application Publication
(10) Pub. No.: US 2023/0182461 A1
(43) Pub. Date: Jun. 15, 2023

(54) METHOD TO PRODUCE A PANEL AND SUCH A PANEL

(71) Applicant: Välinge Innovation AB, Viken (SE)

(72) Inventors: Pontus GAMSTEDT, Kattarp (SE); Per JOSEFSSON, Ramlösa (SE); Christoffer NILSSON, Helsingborg (SE)

(73) Assignee: Välinge Innovation AB, Viken (SE)

(21) Appl. No.: 18/063,829

(22) Filed: Dec. 9, 2022

(30) Foreign Application Priority Data
Dec. 10, 2021 (SE) 2151506-9
Dec. 10, 2021 (SE) 2151507-7

(51) Int. Cl. B32B 37/12; B32B 37/10; B32B 7/12; B32B 29/06; B32B 21/14; B32B 9/00; B32B 9/06; B32B 9/04; B32B 27/40; B32B 27/10; B32B 21/08; C09J 175/04; C09J 179/06

(52) U.S. Cl. CPC B32B 37/1207; B32B 37/1027; B32B 7/12; B32B 29/06; B32B 21/14; B32B 9/002; B32B 9/06; B32B 9/042; B32B 27/40; B32B 9/045; B32B 27/10; B32B 21/08; C09J 175/04; C09J 179/06; B32B 2309/02; B32B 2309/12; B32B 2037/1215; B32B 2317/125; B32B 2317/16; B32B 2260/028; B32B 2260/046; B32B 2307/7265; B32B 2307/308; B32B 2262/067; B32B 2250/40; B32B 2309/04; B32B 2305/30; B32B 2274/00; B32B 2255/26

(57) ABSTRACT

A method to produce a panel. The method includes providing a core having a first surface, providing a surface layer including a substantially uncured amino resin, applying an hydrolysable adhesive on the first surface of the core and/or on a surface of the surface layer adapted to face the core, arranging the surface layer on the first surface of the core, pressing the surface layer to the core to form a panel by applying heat and pressure in a press, thereby adhering the surface layer to the core by the hydrolysable adhesive and curing the amino resin of the surface layer. Also such a panel.

### CROSS REFERENCE TO RELATED APPLICATIONS

The present application claims the benefit of Swedish Application No. 2151506-9, filed on Dec. 10, 2021, and the benefit of Swedish Application No. 2151507-7, filed on Dec. 10, 2021. The entire contents of each of Swedish Application No. 2151506-9 and Swedish Application No. 2151507-7 are hereby incorporated herein by reference in their entirety.

### TECHNICAL FIELD

Embodiments of the present disclosure relate to a method to produce a panel, such as a building panel, including applying a hydrolysable adhesive, and such a panel including a hydrolysable adhesive. Embodiments of the present disclosure relate to a method of forming an intermediate substrate, intended to form to a panel, such as a building panel.

### TECHNICAL BACKGROUND

Laminate is a well-known surface material for various types of panels such as floor panels, furniture components, worktops, etc. Such laminates may be so called direct pressed laminate (DPL) or high pressure laminate (HPL). A high pressure laminate (HPL) is pressed in a first process, and thereafter glued to a core, while a direct pressed laminate (DPL) is directly pressed to a core. The core is conventionally a wood-based board such as HDF, MDF, OSB or particleboard.

A laminate surface comprises one or several papers impregnated with a thermosetting resin. The thermosetting resins most frequently used are amino resins such as melamine formaldehyde or urea formaldehyde. One of the paper layers may be provided with a décor, for example a printed décor. Another layer may be a so-called overlay provided with abrasive particles in order to provide wear and/or scratch resistance of the surface.

When using a direct pressed laminate (DPL), the thermosetting resin of the impregnated paper is cured during the pressing process, simultaneously as the impregnated paper is adhered to the core by the resin. An amino resin, which is frequently used in the industry, is crosslinked in a condensation reaction, wherein water is formed. When pressing a paper impregnated with an amino resin, the amino resin is crosslinked in the condensation reaction and water is formed. When pressing the paper to a core of a wood-based board, such as HDF, MDF, OSB or particleboard, the wood-based board can absorb the water formed by the condensation reaction. During pressing, the water is usually present in gaseous form due to high temperature and pressure in the press.

If the core to which the resin impregnated paper is pressed to cannot absorb the water formed by the condensation reaction, blistering occurs. As the water, in gaseous phase, cannot be absorbed in the core, blisters are formed between the resin impregnated paper and the core. Presence of blisters is undesired both from an aesthetically point of view and technically as inferior adhesion between the paper layer and the core may occur.

When pressing a paper impregnated with an amino to a so-called water-resistant core, for example a thermoplastic board with inorganic fillers, or an inorganic board such an MgO board, blistering occurs during pressing. In order to avoid this problem, the resin impregnated paper is pressed, and the resin is cured, in a separate pressing process. The cured resin impregnated paper is thereafter adhered to the core by an adhesive, as described among other in EP3269543 A1.

Alternatively, the resin impregnated paper may be pressed to a water-resistant core in a hot-cold process, wherein the resin impregnated paper is first cured at high temperature in a hot press step. Thereafter, the press or the resulting product is actively cooled in a cooling step, wherein the resin impregnated paper is adhered to the core by an adhesive.

A process including cooling is described in EP3468790 A1 and EP3269543 A1 for adhering a resin impregnated paper to a polyurethane core.

### SUMMARY

It is an object of at least embodiments of the present disclosure to provide an improvement over the above-described techniques and known art.

According to a first aspect of the disclosure, a method to produce a panel is provided. The method comprises:

providing a core having a first surface,

providing a surface layer comprising a substantially uncured amino resin,

applying an hydrolysable adhesive applied on the first surface of the core and/or on a surface of the surface layer adapted to face the core,

arranging the surface layer on the first surface of the core,

pressing the surface layer to the core to form a panel by applying heat and pressure in a press, thereby adhering the surface layer to the core by the hydrolysable adhesive and curing the amino resin of the surface layer.

The panel may be a building panel, such as a floor panel, a furniture component, a worktop, a wall panel, a ceiling panel.

After the hydrolysable adhesive has been applied, the core may be stored for a period of time prior to applying the surface layer.

By a hydrolysable adhesive is understood to mean an adhesive being reactive in a hydrolysis reaction, i.e., in a reaction in which a molecule of water breaks one or more chemical bonds.

In one example, water resulting from the condensation reaction of the amino resin during pressing is at least partly consumed in the hydrolysis reaction of the hydrolysable adhesive. Thereby, blistering is at least reduced. The amino resin of the surface layer may be cured, and the surface layer can be adhered to the core in one pressing operation.

By substantially uncured is understood to mean that the amino resin being primary in its A- or B-state, for example, at least 90 wt % of the amino resin may be in the A- or B-state. Thermosetting binders, including amino resins, may be classified to be in either an A-, B-, or C-stage according to their extent of reaction compared to the extent of reaction at gelation. A thermosetting binder, such as an amino resin, in the A-stage, the extent of reaction is less than the extent of reaction at gelation, i.e., uncured. A thermosetting binder, such as an amino resin, in the B-stage is close to the gel point. A thermosetting binder, such as an amino resin, in the C-stage is well past the gel point. In the A-stage a thermosetting binder is soluble and fusible. In the B-stage a thermosetting resin is still fusible but is barely soluble. In the C-stage a thermosetting binder is highly crosslinked and both infusible and insoluble. (Principles of Polymerization, George Odian, 3rd edition). By cured, or substantially cured, is understood to mean that at least 90 wt % of the amino resin may be in the C-state

After pressing, the amino resin may be substantially in its C-stage, such as at least 90 wt % of the amino resin may be in the C-state.

During pressing, simultaneously as crosslinking and curing the amino resin of the surface layer, the surface layer may be adhered to the first surface of the core by the hydrolysable adhesive.

No cooling takes place after pressing. By no cooling is understood to mean no active cooling. For a process with no cooling, the temperature may not be actively lowered after pressing.

The pressing includes a hot-hot pressing process.

The press may have a temperature of at least 100° C., preferably of at least 130° C., when pressure is released.

The press may have a temperature of at least 100° C., preferably of at least 130° C., when the panel is removed from the press.

During pressing, a temperature exceeding 100° C. may be at least substantially maintained, or maintained, until pressure is released. Consequently, the pressing operation is a hot-hot pressing operation.

During pressing, a temperature exceeding 130° C. may be at least substantially maintained, or maintained, until pressure is released.

The press may have a temperature of at least 100° C., preferably of at least 130° C., when pressure is released.

The press may have a temperature of at least 100° C., preferably of at least 130° C., when the panel is removed from the press.

During pressing, a temperature exceeding 100° C. may be substantially maintained, or maintained, until the panel is removed from the press.

During pressing, a temperature exceeding 130° C. may be substantially maintained, or maintained, until the panel is removed from the press.

Pressing may comprise applying heat having a temperature exceeding 140° C.

Pressing may comprise applying heat of a temperature exceeding 100° C., preferably exceeding 140° C., when pressure is applied.

The pressing temperature may not be lower than 100° C. during the pressing operation.

The pressing temperature may not be lower than 130° C. during the pressing operation.

The step of pressing may consist of a single press cycle. The single press cycle may be a hot-hot press cycle.

Pressing may comprise applying pressure by means of at least one press plate or press belt, and wherein pressure may be released in a heated state of said press plate or press belt.

No active cooling may take place after the step of applying pressure.

No cooling of a press surface, such as a press surface of a press plate or press belt, may take place after applying heat and pressure. By no cooling is understood to mean no active cooling, such as any means to reduce the heat energy of the press surface.

Pressing may comprise applying a pressure of at least 10 bar and a temperature of at least 130° C. during a pressing time of at least 10 s.

Pressure applied may be in the range of 10-80 bar.

Pressure may be applied during 10-90 s.

The temperature may be 130-235° C. The temperature may be measured at the press surface of the press belt or of the press belt.

The hydrolysable adhesive may be a hydrolysable hot melt.

The hydrolysable adhesive may comprise a group selected from: an ester group, a urethane group, an amide group, and an ethylene vinyl acetate group.

The amino resin may be melamine formaldehyde, urea formaldehyde, or a combination or co-polymer thereof. The amino resin is adapted to crosslink in a polycondensation reaction.

The hydrolysable adhesive may be adapted to react with water at least partly resulting from a polycondensation reaction of said amino resin in a hydrolysis reaction.

The surface layer may comprise at least one paper and said amino resin.

Said at least one paper may be impregnated with the amino resin prior to pressing, or may be impregnated by the amino resin during pressing.

The surface layer may be formed by applying the amino resin in powder or liquid form. The surface layer may be formed by pressing the amino resin, optionally with fillers and pigments, to a layer during pressing.

The surface layer may comprise a wood veneer layer and the amino resin.

A binder of the core may be a thermoplastic binder. The core may comprise a thermoplastic binder. The core may be made of the thermoplastic material.

A binder of the core may be an inorganic binder. The core may comprise an inorganic binder.

A binder of the core may be a thermosetting binder.

The core may comprise fillers. The core may comprise organic and/or inorganic fillers. The core may comprise fillers other than wood material.

The core may be water resistant. Water resistance may be determined by determining swelling in thickness of the core after immersion in water, as measured according to EN317:1993. Swelling of the core in thickness after immersion in water may be less than 5% as measured according to EN317:1993. Swelling of the core in thickness after immersion in water may be less than 3% as measured according to EN317:1993.

According to a second aspect of the disclosure, a panel is provided. The panel may be a building panel, such as a floor panel, a furniture component, a worktop, a wall panel, a ceiling panel. The panel comprises a core and a surface layer, wherein the surface layer comprises an amino resin and is adhered to the core by a hydrolysable adhesive, and wherein the core is water resistant as defined by having a swelling in thickness after immersion in water being less than 5% as measured according to EN317:1993, such as being less than 3% as measured according to EN317:1993.

By a hydrolysable adhesive is understood to mean an adhesive reactive in a hydrolysis reaction, i.e., in a reaction in which a molecule of water breaks one or more chemical bonds.

The amino resin may be substantially cured. By substantially cured in understood to mean that as at least 90 wt % of the amino resin may be in the C-state.

The hydrolysable adhesive may be a hydrolysable hot melt.

The hydrolysable adhesive may comprise a group selected from: an ester group, a urethane group, an amide group, and an ethylene vinyl acetate group.

The amino resin may be melamine formaldehyde, urea formaldehyde, or a combination or co-polymer thereof. The amino resin is adapted to crosslink in a polycondensation reaction.

The hydrolysable adhesive may be adapted to react with water at least partly resulting from a polycondensation reaction of said amino resin in a hydrolysis reaction.

The surface layer may comprise at least one paper and said amino resin.

The surface layer may be formed by applying the amino resin in powder or liquid form.

The surface layer may comprise a wood veneer layer and the amino resin.

A binder of the core may be a thermoplastic binder. The core may comprise a thermoplastic binder. The core may be made of the thermoplastic material. A thermoplastic material is a material that exhibits thermoplastic properties. Typically a thermoplastic material comprises at least 10 wt % of thermoplastic resin.

A binder of the core may an inorganic binder. The core may comprise an inorganic binder.

A binder of the core may be a thermosetting binder.

The core may comprise fillers. The core may comprise organic and/or inorganic fillers. The core may comprise fillers other than wood material.

The core may be a water-resistant core. Water resistance may be determined by determining swelling in thickness of the core after immersion in water, as measured according to EN317:1993.

According to a third aspect, a method to form an intermediate substrate is provided. The method comprises

providing a substrate having a first surface,

applying an adhesive on the first surface of the substrate,

storing the substrate with the adhesive applied on the first surface of the substrate prior to adhering the substrate to a surface layer or to a core.

The substrate may be intended to form a core in a subsequent process, for example a core which is intended to be provided with a surface layer in a subsequent process.

The substrate may be intended to form a surface layer in a subsequent process, for example a surface layer which is intended to be applied to a core in a subsequent process.

The substrate formed by the method may be storable. The substrate may be storable for a period of time, for example for a period exceeding 24 hours.

The method may further comprise stacking a plurality of said substrates after applying the adhesive without any intervening layers between adjacent substrates.

The method may further comprise stacking a plurality of said substrates when the adhesive has solidified.

No intervening layers between adjacent substrates may be provided.

After the adhesive has solidified, and for some types of adhesives, crystallized, the substrates can be stacked.

The adhesive may be a hot melt adhesive.

The adhesive may be a hydrolysable adhesive.

The hydrolysable adhesive may be a hydrolysable hot melt.

The hydrolysable adhesive may comprise a group selected from: an ester group, a urethane group, an amide group, and an ethylene vinyl acetate group.

The hydrolysable adhesive may be adapted to react with water at least partly resulting from a polycondensation reaction of an amino resin in a hydrolysis reaction.

The substrate may comprise at least one paper layer and a thermosetting resin. The substrate may be a surface layer comprising comprise at least one paper layer and a thermosetting resin.

The substrate may comprise at least one paper layer and an amino resin. The substrate may be a surface layer comprising at least one paper layer and an amino resin.

The substrate may comprise a wood veneer layer and a thermosetting resin such as an amino resin. The substrate may be a surface layer comprising a wood veneer layer and a thermosetting resin such as an amino resin.

The substrate may comprise a thermosetting resin, such as an amino resin, and fillers. The substrate may be a surface layer comprising a thermosetting resin, such as an amino resin, and fillers.

The thermosetting resin, such as an amino resin, may be substantially uncured. By substantially uncured is understood to mean that the amino resin being primary in its A- or B-state, for example, at least 90 wt % of the amino resin may be in the A- or B-state.

The amino resin may be melamine formaldehyde, urea formaldehyde, or a combination or co-polymer thereof. The amino resin is adapted to crosslink in a polycondensation reaction.

The substrate may be a water-resistant substrate as defined by swelling in thickness after immersion in water being less than 5% as measured according to EN317:1993, preferably being less than 3% as measured according to EN317:1993.

The substrate may be a core having a swelling in thickness after immersion in water being less than 5% as measured according to EN317:1993, preferably being less than 3% as measured according to EN317:1993.

The step of providing the substrate may comprise forming the substrate by a pressing or extrusion process. The adhesive may be applied to the substrate prior to cooling the substrate after pressing or extrusion.

A binder of the substrate may a thermoplastic binder. The substrate may comprise a thermoplastic binder. The substrate may be made of the thermoplastic material.

A binder of the substrate may an inorganic binder. The substrate may comprise an inorganic binder.

A binder of the core may be thermosetting binder.

A width of the substrate may be equal to or exceeding 0.5 m. A length of the substrate may be equal to or exceeding 1 m.

A thickness of the substrate may be equal to or less than 0.5 mm.

A thickness of the substrate may be 3-15 mm.

According to a fourth aspect, a method to produce a panel is provided. The method comprises

providing an intermediate substrate according to the third aspect,

applying a core or a surface layer to the first surface of the intermediate substrate,

pressing the intermediate substrate to the core or to the surface layer to form a panel by applying heat and pressure in a press, thereby adhering the intermediate substrate to the core or to the surface layer by the adhesive.

### BRIEF DESCRIPTION OF THE DRAWINGS

The present disclosure will by way of example be described in more detail with reference to the appended schematic drawings, which show examples of the present disclosure.

FIG. 1 shows schematically a method to produce a panel according to a first example.

FIG. 2 shows schematically a method to produce a panel according to a second example.

FIG. 3 shows schematically a method to produce a panel according to a third example.

FIG. 4 shows schematically a method to produce a panel according to a fourth example.

FIG. 5 shows schematically a panel.

FIG. 6A-6D shows examples of hydrolysable functional groups.

FIG. 7 shows a hydrolysis reaction.

FIG. 8 shows schematically a method to form an intermediate substrate according to a first example.

FIG. 9 shows schematically a first example of a stack of intermediate substrates.

FIG. 10 shows schematically a method to form an intermediate substrate according to a second example.

FIG. 11 shows schematically a second example of a stack of intermediate substrates.

FIG. 12 shows schematically a method to produce a panel.

### DETAILED DESCRIPTION

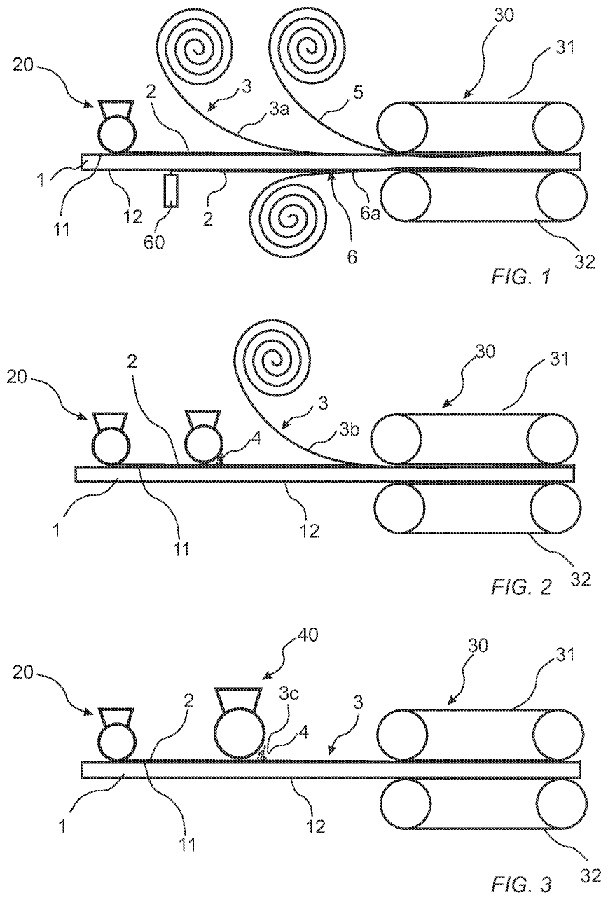

A method to produce a panel will be described with reference to FIGS. 1-4. In the examples shown in FIG. 1-4, a core 1 is provided. The core 1 may be water resistant, such as being a water-resistant core. By water resistant is understood to mean a core having a swelling in thickness after immersion in water being less than 5% as measured according to EN317:1993, such as being less than 3% as measured according to EN317:1993.

The core 1 may comprise a binder. The core may comprise 10-95 wt % of binder, such as 15-80 wt % of binder, such as 20-60 wt % of binder.

The core 1 may comprise a thermoplastic binder. The core 1 may be formed of a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), polyethylene terephthalate (PET), or a combination thereof.

In another example, the core 1 may comprise an inorganic binder, such as a mineral binder. The mineral binder may magnesium oxide, optionally, magnesium chloride and/or magnesium sulphate.

In another example, the core 1 may comprise a thermosetting binder.

The core 1 may further comprise fillers. The fillers may be organic, or inorganic. The core 1 may further comprise 5-90 wt % of filler, such as 30-85 wt %, such as 40-80 wt % filler.

The inorganic fillers may be calcium carbonate, barium sulphate, stone powder, talc, and/or fly ash. The organic fillers may be wood particles such as wood dust or wood fibres. The organic fillers may be plant fillers such as hemp, rice husk, sisal, flax etc.

The core 1 may be of the type referred to as WPC (Wood Plastic Composite, Waterproof Core or Waterproof Plastic Composite), SPC (Stone Plastic Composite), MgO board, LVT (Luxury Vinyl Tile), or fibre cement board.

In one example, the core 1 may be a wood-based board.

The core 1 may have a rectangular shape. The core 1 has a first surface 11 and a second surface 12, opposite the first surface 11.

A hydrolysable adhesive 2 is applied on the first surface 11 of the core 1, as shown in FIGS. 1-4. The hydrolysable adhesive 2 may be applied by a roller coating device 20, as shown in FIGS. 1-4. In other examples, the hydrolysable adhesive 2 may be applied by spraying or extrusion, such as slot extrusion or bead extrusion.

In the examples shown in FIGS. 1-4, the hydrolysable adhesive 2 is applied in molten form, for example, as an emulsion comprising the hydrolysable adhesive 2. The emulsion may be an aqueous emulsion comprising the hydrolysable adhesive 2. In one example, the hydrolysable adhesive 2 may be applied in powder form. The hydrolysable adhesive 2 can be applied as a film.

The hydrolysable adhesive 2 may at least partly cover the first surface 11 of the core 1. The hydrolysable adhesive 2 may form an adhesive layer on the first surface 11 of the core 1. The layer formed by the hydrolysable adhesive 2 may be continuous over the first surface 11 of the core 1.

The hydrolysable adhesive 2 may be applied in an amount of 25-500 g/m², such as 50-300 g/m² or 75-200 g/m².

The hydrolysable adhesive 2 is adapted to react in hydrolysis reaction, i.e., in a reaction in which a molecule of water breaks one or more chemical bonds. The hydrolysable adhesive 2 is adapted to react with water at least partly resulting from a polycondensation reaction of the amino resin in a hydrolysis reaction.

The hydrolysable adhesive 2 may be a hydrolysable hot melt. The hydrolysable hot melt may be applied in molten or powder form in the above-described manner.

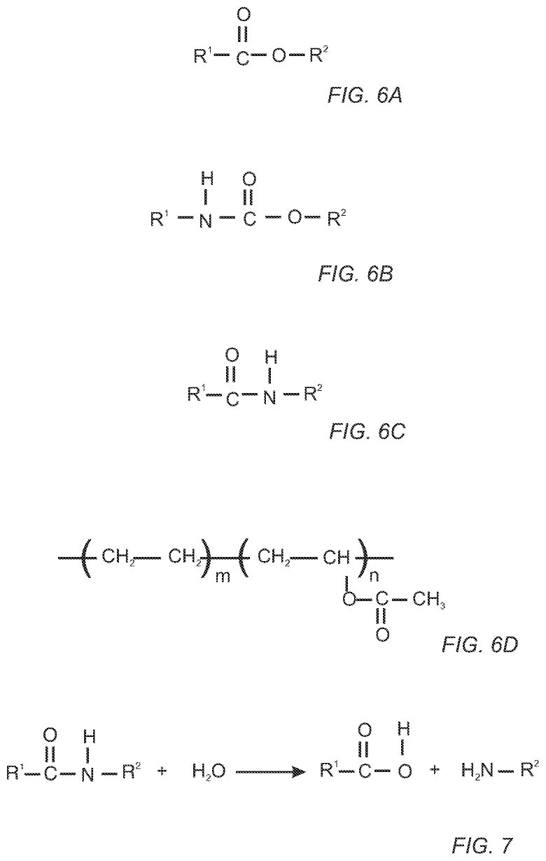

The hydrolysable adhesive 2 may comprise at least one hydrolysable functional group. The hydrolysable functional group may be an ester group, a urethane group, an amide group, or an ethylene vinyl acetate group. The chemical formulas of said examples functional groups are shown in FIGS. 6A-6D, wherein FIG. 6A shows an ester group, FIG. 6B shows a urethane group, FIG. 6C shows an amide group, and FIG. 6D shows an ethylene vinyl acetate (EVA) group. R¹ and R² may be organic groups, such as any alkyl or aryl, or hydrogen.

The hydrolysable adhesive 2 may be thermoplastic polyurethane (TPU), co-polyamide (Co-PA), co-polyester (Co-PES), ethylene vinyl acetate (EVA), or a combination thereof.

Optionally, the hydrolysable adhesive 2 may be dried and/or subjected to heat, for example being placed in an oven, prior to applying a surface layer.

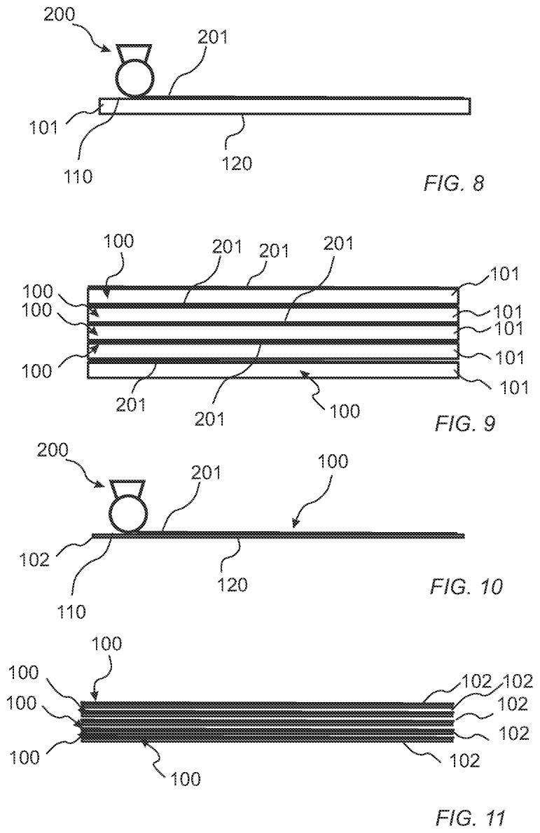

The core 1 can be stored for a period of time prior to applying a surface layer, as described below. The hydrolysable adhesive 2 can be applied in a process separate from applying a surface layer and separate from pressing, as discussed below with reference to FIGS. 8-12.

In the examples shown in FIGS. 1-4, a surface layer 3 is applied on the hydrolysable adhesive 2, on the first surface 11 of the core 1. Common for the example of surface layers 3 described below is that the surface layer 3 comprises an amino resin.

An example of a surface layer 3 comprising an amino resin will now be described in more detail with reference to FIG. 1. In the example shown in FIG. 1, the surface layer 3 comprises at least one resin impregnated paper 3a. The resin impregnated paper 3a is impregnated by an amino resin. The amino resin may be melamine formaldehyde, urea formaldehyde, or a combination or co-polymer thereof.

The amino resin of the impregnated paper 3a is substantially uncured when the impregnated paper 3a is applied on the hydrolysable adhesive 1. By substantially uncured is understood to mean in its A- or B-stage, for example, at least 90 wt % of the amino resin may be in the A- or B-state.

The impregnated paper 3a is provided in form of a roll of the impregnated paper 3a, i.e., as a continuous web of impregnated paper 3a. In another example, the impregnated paper 3a is provided in form of sheets of the impregnated paper 3a.

More than one layer of the amino resin impregnated paper 3a of the type described above may be applied. For example, a first amino resin impregnated paper 3a may be applied on the hydrolysable adhesive 2. A second amino resin impregnated paper 5 may be applied on the first amino resin impregnated paper 3a. The first amino resin impregnated paper 3a and the second amino resin impregnated paper 5 may together form the surface layer 3. The first amino resin impregnated paper 3a may be a décor layer, such as being provided with a print. The second amino resin impregnated paper 5 may be an overlay paper, provided with abrasive resistant particles. The overlay may be substantially transparent.

In one example (not shown), the hydrolysable adhesive 2 is applied on a surface of the amino resin impregnated paper 3a adapted to face the first surface 11 of the core 1. The hydrolysable adhesive may also be applied on both the amino resin impregnated paper 3a and on the first surface 11 of the core 1.

A balancing layer 6 may be provided on a second surface 12 of the core 1, opposite the surface layer 3. The balancing layer 6 may be adapted to counteract forces formed by the amino resin of the surface layer 3 during pressing. In the example shown in FIG. 1, a balancing layer 6 comprising an amino resin impregnated paper 6a is provided. The hydrolysable adhesive 2 may be applied on the second surface 12 of the core, for example by spaying in a spraying device 60 as shown in FIG. 1. The hydrolysable adhesive 2 may be of the same type as described above. On the hydrolysable adhesive 2, the amino resin impregnated paper 6a is applied.

A second example of the surface layer 3 comprising the amino resin will now be described with reference to FIG. 2. In the example shown in FIG. 2, the surface layer 3 applied on the core 1 comprises an unimpregnated paper 3b and the amino resin 4. Similar to the example in FIG. 1, the unimpregnated paper 3b may be provided in form of a roll of the unimpregnated paper 3b, i.e., as a continuous web of unimpregnated paper 3b. In another example, the impregnated paper 3b is provided in form of sheets of the impregnated paper 3b.

Prior to applying the unimpregnated paper 3b on the first surface 11 of the core 1, an amino resin 4 is applied on the hydrolysable adhesive 2 on the first surface 11 of the core 1. The amino resin may be applied onto the adhesive layer formed by the hydrolysable adhesive 2 described above. In another example (not shown), the amino resin is applied on a surface of the unimpregnated paper 3b adapted to the face the first surface 11 of the core 1. In one example, the amino resin may be applied on both the unimpregnated paper 3b and on the hydrolysable adhesive 2 applied on the core 1.

The amino resin 4 may be applied in liquid form, or in powder form. In one example, the amino resin 4 is scattered onto the hydrolysable adhesive 2 applied on the core 1. In another example, the amino resin 4 in liquid form is applied on a surface of the unimpregnated paper 3b adapted to the face the first surface 11 of the core 1.

The amino resin 4 may be applied in an amount of 25-500 g/m², such as 50-300 g/m² or 75-200 g/m².

As described above, the amino resin may be melamine formaldehyde, urea formaldehyde, or a combination or co-polymer thereof.

The amino resin is substantially uncured when being applied on the hydrolysable adhesive 1, and/or when being applied on the unimpregnated paper 3b. By substantially uncured is understood to mean in its A- or B-stage, for example, at least 90 wt % of the amino resin may be in the A- or B-state.

During subsequent pressing, the amino resin 4 will impregnate the unimpregnated paper 3b, such that after pressing, an impregnated paper is obtained, forming the surface layer 3.

As discussed above with reference to FIG. 1, more than one layer of an unimpregnated paper 3b of the type described above may be applied. For example, a first unimpregnated paper 3b may be applied on the hydrolysable adhesive 2. A second unimpregnated paper (not shown) may be applied on the first unimpregnated paper 3b. An amino resin of the above described type may be applied between the first and second unimpregnated paper.

The first unimpregnated paper 3b and said amino resin 4 may together form the surface layer 3, optionally including the second unimpregnated paper (not shown). The first unimpregnated paper 3a may be a décor layer, such as being provided with a print. The second unimpregnated paper may be an overlay paper, provided with abrasive resistant particles. The overlay may be substantially transparent.

A third example of the surface layer 3 comprising the amino resin will now be described in more detail with reference to FIG. 3. In the example shown in FIG. 3, the surface layer 3 comprises a layer of amino resin 4 and optional fillers. In FIG. 3, an amino resin 4 is applied in powder form on the hydrolysable adhesive 2 on the first surface 11 of the core 1. The amino resin may be applied in form of a mix 3c comprising the amino resin 4, fillers and pigments. The fillers may be organic fillers, such as wood particles, and or inorganic fillers, such as calcium carbonate. The amino resin 4, or the mix 3c comprising the amino resin 4, may be applied by an application device 40, such as a scattering device. The amino resin 4, or the mix 3c comprising the amino resin, forms the surface layer 3.

The mix 3c may comprise 30-70 wt %, such as 40 to 60 wt %, such as 45 to 55 wt % of amino resin 4.

The mix 3c may comprise 10-60 wt %, such 20-50 wt %, such as 30-40 wt % of wood particles.

The mix 3c may comprise 0-10 wt %, such as 2-8 wt %, such as 3-7 wt % aluminum oxide.

The mix 3c may comprise 5-25 wt %, such as 8-20 wt %, such as 10-18 wt % of inorganic filler and pigments.

The inorganic filler may be chalk and/or barium sulfate.

In another example (not shown), the amino resin is applied in liquid form on the hydrolysable adhesive 2. In addition to the amino resin, the solution may include fillers and pigments as described above. The amino resin, optionally with fillers and pigments, forms the surface layer 3.

In yet another example (not shown), the amino resin 4, optionally with fillers and/or pigments, may be applied to a carrier, such as a paper sheet, prior to being applied to the core 1. Moisture may be applied to the amino resin such that the amino resin gets sticky and adheres to the carrier. The carrier, provided with the amino resin, may be applied on the hydrolysable adhesive 2 on the first surface 11 of the core 1.

As described above, the amino resin 4 may be melamine formaldehyde, urea formaldehyde, or a combination or co-polymer thereof.

When applied on the hydrolysable adhesive 2 on the first surface 11 of the core 1, the amino resin 4 is substantially uncured. By substantially uncured is understood to mean in its A- or B-stage, for example, at least 90 wt % of the amino resin may be in the A- or B-state.

During subsequent pressing, the amino resin 4 will crosslink and form a solid surface layer 3. In one example, an additional layer (not shown) may be applied on the amino resin 4. The additional layer may comprise a paper layer such as an overlay or decorative paper.

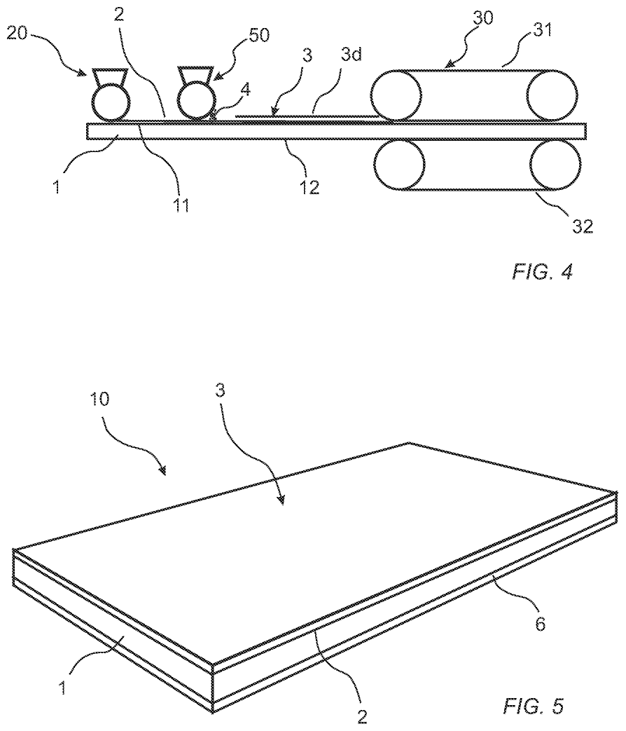

A fourth example of the surface layer 3 comprising the amino resin will now be described in more detail with reference to FIG. 4. In the example shown in FIG. 4, the surface layer 3 comprises a wood veneer layer 3d and the amino resin 4. In FIG. 4, the amino resin 4 is applied by an application device 50 on the hydrolysable adhesive 2 on the first surface 11 of the core 1. The amino resin 4 may be applied in liquid or powder form. In addition to amino resin, fillers and/or pigments may be applied.

A wood veneer layer 3d is applied on the amino resin 4 applied on the hydrolysable adhesive 2 on the first surface 11 of the core 1. The wood veneer layer 3d may have a thickness of less than 1 mm. The wood veneer layer 2 may be or comprise an oak veneer, maple veneer, birch veneer, walnut veneer, ash veneer, and pine veneer.

As described above, the amino resin 4 may be melamine formaldehyde, urea formaldehyde, or a combination or co-polymer thereof.

When applied on the hydrolysable adhesive 2 on the first surface 11 of the core 1, the amino resin 4 is substantially uncured. By substantially uncured is understood to mean in its A- or B-stage, for example, at least 90 wt % of the amino resin may be in the A- or B-state.

During pressing, the amino resin 4 may impregnate to the wood veneer layer 3d and together form the surface layer 3.

A balancing layer may also be provided in the examples shown in FIGS. 2-4. The balancing layer may be of the same type as the surface layer 6. The balancing layer may be provided on the second surface 12 of the core 1 prior to entering the process described with reference to FIGS. 2-4. In one example, the hydrolysable adhesive 2 is applied on the second surface 12 of the core 1, similar to disclosed above. The hydrolysable adhesive 2 may be applied when the second surface 12 of the core 1 faces upwards. A balancing layer of a type corresponding to the surface layer 3 may be applied on the hydrolysable adhesive 2. An amino resin may be applied, for example scattered in powder form or applied in liquid form, on the hydrolysable adhesive 2 on the second surface 12 of the core 1 when facing upwards. The amino resin may comprise fillers. In one example, the amino resin is provided in form of an amino resin impregnated paper. An additional layer, such as a paper layer or wood veneer layer may be applied on the amino resin. The balancing layer 6 may be of corresponding type to the surface layer. If the surface layer 3 comprises a paper layer, the balancing layer may comprise a paper layer. If the surface layer 3 comprises a wood veneer layer, the balancing layer may comprise a wood veneer layer. When the hydrolysable adhesive, the amino resin, and any additional layer, are applied, the core 1 may be turned such as the first surface 11 of the core 1 faces upwards, as shown in FIGS. 2-4.

In the examples described above with reference to FIGS. 1-4, the hydrolysable adhesive 2 is applied on the core 1. As an alternative, or complement, the hydrolysable adhesive 2 may be applied on a surface of the surface layer 3, intended to face the core 1.

The core 1, the surface layer 3, and optional balancing layer 6 of any of the examples described above are pressed together in a press 30 to form a panel 10, as shown in FIGS. 1-4. The disclosure below is applicable for examples in any one of FIGS. 1-4.

The press 30 may be a continuous press, as shown in FIGS. 1-4, or a static press. The press 30 may comprise press plates, for example as in a static press, or press belts 31, 32 as in a continuous press.

During pressing, the amino resin 4 of the surface layer 3 is cured. In the example shown FIG. 1, the amino resin 4 of said at least amino resin impregnated paper 3a is cured. In the example shown FIG. 2, the amino resin 4 impregnates the previously unimpregnated paper 3b and the amino resin 4 is cured during pressing. In the example shown in FIG. 3, the amino resin 4 forming the surface layer 3 is cured. In FIG. 4, the amino resin 4 impregnates the wood veneer layer 3d and is cured during pressing. By cured in understood to that the amino resin is substantially in its C-stage, such as at least 90 wt % of the amino resin may be in the C-state.

Simultaneously as crosslinking and curing the amino resin 4 of the surface layer 3, the surface layer 3 is adhered to the first surface 11 of the core 1 by the hydrolysable adhesive 2.

If a balancing layer 6 comprising an amino resin is provided, the amino resin of the balancing layer 6 is cured and crosslinked simultaneously as the balancing layer 6 is adhered to the second surface 12 of the core 1 by the hydrolysable adhesive 2.

In the example of the surface layer 3 shown in FIG. 1, the amino resin impregnated paper 3a is adhered to the first surface 11 of the core 1 by the hydrolysable adhesive 2 and the amino resin is cured. In the example of the surface layer 3 shown in FIG. 2, the previously unimpregnated paper 3b has been impregnated by the amino resin 4 and is adhered to the first surface 11 of the core 1 by the hydrolysable adhesive 2 and the amino resin 4 is cured. In the example of the surface layer 3 shown in FIG. 3, the amino resin 4 is cured, thereby forming the surface layer 3, and is adhered to the first surface 11 of the core 1 by the hydrolysable adhesive 2. In the example of the surface layer 3 shown in FIG. 4, the amino resin has 4 impregnated the wood veneer layer 3d and the amino resin 4 is cured.

Blisters and/or inferior adhesion between the surface layer 3 and the core 1 can be prevented, or at least reduced, by the hydrolysis reaction of the hydrolysable adhesive 2. During hydrolysis, the water molecule breaks up covalent bonds in the polymer chain. In the present process, vapour formed by the condensation reaction of the amino resin upon crosslinking reacts with the polymer chains in the hydrolysable adhesive 2. Thereby, the hydrolysis reaction consumes, or at least partly consumes, water formed by the condensation reaction of the amino resin. Consequently, occurrence of blisters is at least reduced and adhesion between the surface layer 3 and the core 1 is improved. An example of a hydrolysis reaction of a polymer including an amide group is shown in FIG. 7.

The hydrolysis reaction of the hydrolysable adhesive 2 allows that a wider range of core materials can be used. The manufacture may not be restricted to use core materials that can absorb vapour formed, such as certain wood-based board materials. Instead, core material being non-absorbing, such as core material being water resistant, can be used in combination with amino resins, wherein the surface layer 3 comprising the amino resin can be crosslinked and adhered to the core 1 in one pressing step. Such water-resistant material can be defined as having a swelling in thickness after immersion in water being less than 5% as measured according to EN317:1993, preferably being less than 3% as measured according to EN317:1993.

FIGS. 1-4 show a continuous press 30 having an upper press belt 31 and a lower press belt 32. In another example, a static press may be used. A static press comprises an upper press plate and a lower press plate.

During pressing, pressure and heat is applied. In the present process, heat is applied during the period of time when pressure is applied. Heat is applied during the complete pressing process. No active cooling, in the meaning of actively decreasing the temperature in the press, takes place during pressing. The press surface or press belt 31, 32 is not intended to be cooled during the pressing operation.

Heat may be applied until the panel 10 is removed from the press 30. Depending on the type of press, heat may be applied until the press 30 opens such that the panel 10 can be removed from the press. In a continuous press, heat may be applied until the panel 10 exits the press 30 such that the panel 10 can be removed from the press. Consequently, the pressing process is a process conventionally referred to as a “hot-hot” process.

A temperature exceeding 100° C. may be maintained until pressure is released. A temperature exceeding 130° C., such as exceeding 140° C., may be maintained until pressure is released.

The press 30 may have a temperature of at least 100° C., preferably of at least 130° C., when pressure is released. Thereby, the pressing operation is a “hot-hot” process. The temperature may be measured at the press surface, for example at the press surface of the press plate or of the press belt 31, 32. A temperature exceeding 100° C. may be maintained until pressure is released. A temperature exceeding 130° C., such as exceeding 140° C., may be maintained until pressure is released. A temperature exceeding 100° C. may be maintained until the panel 10 is removed from the press 30. A temperature exceeding 130° C., such as exceeding 140° C., may be maintained until the panel 10 is removed from the press 30.

The temperature may differ during the pressing operation, but the temperature is not lower than 100° C.

The temperature may differ during the pressing operation. but the temperature is not lower than 100° C. The temperature may exceed 100° C., such as exceed 130° C., during the entire pressing process.

In case of a continuous press 30, heat may be applied in all pressure zones of the continuous press 30, such that heat is applied to the panel 10 until the panel 10 exits the press 30 between the press belts 31, 32. It is contemplated that the temperature may vary between different zones in a continuous press. However, the temperature may exceed 100° C. in all zones of the press.

The heat carrier of the press 30 may be heated until the pressure is released. Consequently, pressure is released in a heated state of the press plate or press belt 31, 32. The heat carrier may be heated to a temperature exceeding 100° C., such as exceeding 130° C., until pressure is released.

During the pressing process, the pressure applied may be in the range of 10-80 bar, such as 30-60 bar. The temperature applied may be in the range of 130-235° C., such as 160-190° C. Heat and pressure may be applied for 10-90 seconds, such as 30-60 seconds.

The temperature may be measured at the press surface, for example at the press surface of the press plate or of the press belt 31, 32.

The pressing process described above may consist of a single press cycle. By single press cycle is understood to mean a single pressing operation including applying heat and pressure without cooling. In the single press cycle, the amino resin of the surface layer 3 is crosslinked as well as the surface layer 3 is adhered to the core 1 by the hydrolysable adhesive 2.

After pressing, a panel 10 is formed, as shown in FIG. 5. The surface layer 3 is adhered to the core 1 by the hydrolysable adhesive 2. The panel 10 may be further processed, for example be divided into individual panels. The panel 10 may be provided with a mechanical locking system. The panel 10 may form a building panel, such as a floor panel, a furniture component, a worktop, a wall panel, a ceiling panel.

The core 1 is of the type above described, such as a water-resistant core. Water resistance may be defined as having a swelling in thickness after immersion in water being less than 5% as measured according to EN317:1993, such as being less than 3% as measured according to EN317:1993. The surface layer 3 is according to the examples described above with reference to FIGS. 1-4. Common for all examples shown is that after pressing, the surface layer 3 comprises cured amino resin.

The surface layer 3 of a panel 10 produced according to the method described with reference to FIG. 1 comprises at least one amino resin impregnated paper 3a.

The surface layer 3 of a panel 10 produced according to the method described with reference to FIG. 2 comprises at least paper 3 which has been impregnated by the amino resin 4.

The surface layer 3 of a panel 10 produced according to the method described with reference to FIG. 3 comprises the amino resin 4, optionally with fillers and/or pigments.

The surface layer 3 of a panel 10 produced according to the method described with reference to FIG. 4 comprises at least one wood veneer layer 3d and the amino resin 4.

The panel 10 shown in FIG. 5 comprises further a balancing layer 6. The balancing layer 6 may comprise an amino resin. The balancing layer 6 may be adhered to the core by the hydrolysable adhesive 2. The balancing layer 6 may have corresponding structure as the surface layer 3.

FIG. 8 shows an example of a process for forming an intermediate substrate 100. In the example shown in FIG. 8, the substrate 100 is form of a core 101. The core 101 may be water resistant, as defined by having a swelling in thickness after immersion in water being less than 5% as measured according to EN317:1993, such as being less than 3% as measured according to EN317:1993.

The core 101 may comprise a thermoplastic binder. The core 101 may be formed of a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), polyethylene terephthalate (PET), or a combination thereof.

In another example, the core 101 may comprise an inorganic binder, such as a mineral binder. The mineral binder may be magnesium oxide, optionally, magnesium chloride and/or magnesium sulphate.

In another example, the core 101 may comprise a thermosetting binder.

The core 101 may further comprise fillers. The fillers may be organic, or inorganic.

The inorganic fillers may be calcium carbonate, barium sulphate, stone powder, talc, and/or fly ash. The organic fillers may be wood particles such as wood dust or wood fibres. The organic fillers may be plant fillers such as hemp, rice, sisal, etc.

The core 101 may be of the type referred to as WPC (Wood Plastic Composite, Waterproof Core, or Waterproof Plastic Composite), SPC (Stone Plastic Composite), MgO board, LVT (Luxury Vinyl Tile), or fibre cement board.

In one example, the core 101 may be a wood-based board.

The core 101 may have a rectangular shape. The core 101 has a first surface 110 and a second surface 120, opposite the first surface 110.

An adhesive 201 is applied on the first surface 110 of the core 101.

The adhesive 201 may be applied by a roller coating device 200, as shown in FIG. 8. In other examples, the adhesive 201 may be applied by spraying or extrusion, such as slot extrusion or bead extrusion.

In the examples shown in FIG. 8, the adhesive 201 is applied in molten form, for example as an emulsion comprising the adhesive 201. The emulsion may be an aqueous emulsion comprising the adhesive 201. In one example, the adhesive 201 may be applied in powder form. The adhesive 201 can be applied as a film.

The adhesive 201 may at least partly cover the first surface 110 of the core 101. For example, the adhesive 201 may cover 50-100%, such as 70-98%, of the surface area of the first surface 110. The adhesive 201 may form an adhesive layer on the first surface 110 of the core 101. The layer formed by the adhesive 201 may be continuous over the first surface 110 of the core 101.

The adhesive 201 may be a hot melt. The adhesive 201 may be a hydrolysable adhesive of the type described above with reference to FIGS. 1-7.

The adhesive 201 may be applied on the core 101 subsequent to forming the core 101, for example after pressing or extrusion of the core 101. The adhesive 201 may be applied to the first surface 110 of the core 101 prior to cooling the core 101, after pressing or extrusion of the core 101.

When applied on the core 101, the adhesive 201 may be dried (not shown). The adhesive 201 may be stored and/or dried at room temperature, or may be subjected by applying heat, for example placed in at an elevated temperature. The adhesive 201 may be dried, or any corresponding process, such that the adhesive 201 has solidified, or for some types of adhesives, crystalized.

The adhesive 201 may also be applied to the second surface 120 of the core 101 (not shown). The adhesive 201 may applied to the second surface 120 of the core 101 in the same manner as to the first surface 120 of the core 101.

When the adhesive 201 has been applied to the core 101, on the first surface 110 or on both the first surface 110 and the second surface 120 or the core 101, an intermediate substrate 100 is formed. In the example shown in FIG. 8, the intermediate substrate 100 is an intermediate core 101.

The intermediate substrate 100, in form of the core 101, is already provided with the adhesive 201, and a further surface layer can be applied to the substrate 100 without applying any adhesive when the surface layer is applied. The adhesive 201 is pre-applied to the intermediate substrate 100. Thereby, the subsequent step of applying a surface layer is simplified. No adhesive has to be handled in the process of applying the surface layer.

The intermediate substrate 100 can then be stored for a period of time, prior to being included in a further process. The intermediate substrate 100 may be storable and/or stackable.

After the adhesive 201 has been applied to the core 101, such that an intermediate substrate 100 is formed, a plurality of intermediate substrates 100 may be stacked on each other, as shown in FIG. 9. After the adhesive 201 has solidified, and for some types of adhesives, crystallized, the substrates 201 can be stacked.

The intermediate substrates 100 may be stacked on each other without any intervening layers between adjacent intermediate substrates 100. The second surface 120 of the intermediate substrate 100 may contact the first surface 110 of an underlying intermediate substrate 100 without any intervening layer. The adhesive 201 applied on the first surface 110 of a first intermediate substate 100 may contact the surface of an underlying intermediate substrate 100 without any intervening layer. The surface of the underlying intermediate substrate 100 may be provided with an adhesive, such that two adhesive layers contact each other.

The intermediate substrates 100 may be stacked for a period of time, such as days or months. The intermediate substrates 100 may be stored in a stack for a period of time, such as days or months.

The intermediate substates 100 may be transported to another location for further processing. Such further processing may be application of a surface layer on the adhesive 201 applied on the intermediate substrate 100, and thereafter pressing to form a panel.

FIG. 10 shows an example of forming an intermediate substrate 100. In the example shown in FIG. 10, the intermediate substrate 100 is a surface layer 102.

In one example, the surface layer 102 may comprise at least one resin impregnated paper. The impregnated paper may be impregnated with a thermosetting resin. The impregnated paper may be impregnated with an amino resin, such as melamine formaldehyde, urea formaldehyde, or a combination or co-polymer thereof. One of the impregnated papers may be provided with a décor, for example a printed décor. Another layer may be a so-called overlay provided with abrasive particles in order to provide wear and/or scratch resistance of the surface.

The thermosetting resin, such as the amino resin, may be substantially uncured. By substantially uncured is understood to mean in its A- or B-stage, for example, at least 90 wt % of the amino resin may be in the A- or B-state.

In another example, the surface layer 102 may comprise a layer comprising thermosetting resin, such as an amino resin, and optional fillers. The thermosetting binder, such as the amino resin, may be applied in powder form or in liquid form. The thermosetting binder, for example the amino resin, may be applied on a carrier, such as a paper sheet. The thermosetting resin, for example the amino resin, may be applied in form of a mix, further comprising fillers and pigments. The fillers may be organic fillers, such as wood particles, and or inorganic fillers, such as calcium carbonate.

In one example, the thermosetting resin, such as the amino resin, may be substantially uncured. By substantially uncured is understood to mean in its A- or B-stage, for example, at least 90 wt % of the amino resin may be in the A- or B-state.

In another example, the thermosetting resin, with optional fillers and optional carrier, may be pre-pressed such as a surface layer 102 is formed.

The amino resin may be melamine formaldehyde, urea formaldehyde, or a combination or co-polymer thereof.

In one example, the surface layer 102 comprises a wood veneer layer. The surface layer may further comprise a thermosetting resin such as an amino resin. The thermosetting resin, such as an amino resin, may be applied on a surface of the wood veneer. In addition to the thermosetting resin, fillers and/or pigments may be included. The wood veneer layer may be or comprise an oak veneer, maple veneer, birch veneer, walnut veneer, ash veneer, and pine veneer. The wood veneer layer may have a thickness of less than 1 mm. The amino resin may be melamine formaldehyde, urea formaldehyde, or a combination or co-polymer thereof.

In one example, the thermosetting resin, such as the amino resin, may be substantially uncured. By substantially uncured is understood to mean in its A- or B-stage, for example, at least 90 wt % of the amino resin may be in the A- or B-state.

In another example, the thermosetting resin, with optional fillers and optional carrier, may be pre-pressed such as the thermosetting resin is pressed to the wood veneer layer.

As shown in FIG. 10, the adhesive 201 is applied to a first surface 110 of the surface layer 102 of any of the above-described type. The adhesive 201 may be applied by a roller coating device 200, as shown in FIG. 10. In other examples, the adhesive 201 may be applied by spraying or extrusion, such as slot extrusion or bead extrusion.

In the examples shown in FIG. 10, the adhesive 201 is applied in molten form, for example as an emulsion comprising the adhesive 201. The emulsion may be an aqueous emulsion comprising the adhesive 201. In one example, the adhesive 201 may be applied in powder form. The adhesive 201 can be applied as a film.

The adhesive 201 may at least partly cover the first surface 110 of the surface layer 102. The adhesive 201 may form an adhesive layer on the first surface 110 of the surface layer 102. The layer formed by the adhesive 201 may be continuous over the first surface 110 of the surface layer 102.

The adhesive 201 may be a hot melt. The adhesive 201 may be a hydrolysable adhesive of the type described above with reference to FIGS. 1-7.

The adhesive 201 may be applied on the surface layer 102 subsequent to forming the surface layer 102.

When applied on the surface layer 102, the adhesive 201 may be dried (not shown). The adhesive 201 may be dried and/or stored at room temperature, or may be subjected to heat, for example placed at an elevated temperature. The adhesive 201 may be dried, or any corresponding process, such that the adhesive 201 has solidified, or for some types of adhesives, crystallized.

The adhesive 201 may also be applied to the second surface 120 of the surface layer 102 as well. The adhesive 201 may applied to the second surface 120 of the surface layer 102 in the same manner as to the first surface 120 of the surface layer 102.

When the adhesive 201 has been applied to the surface layer 102, on the first surface 110 or on both the first surface 110 and the second surface 120 of the surface layer 102, an intermediate substrate 100 is formed. In the example shown in FIG. 10, the intermediate substrate 100 is an intermediate surface layer 102.

The intermediate substrate 100, in form of the surface layer 102, is already provided with the adhesive 201, and the surface layer 102 can be applied to a core without applying any adhesive when the surface layer 102 is to be applied to the core. The adhesive 201 is pre-applied to the intermediate substrate 100, in form of the surface layer 102. Thereby, the subsequent step of applying the surface layer 102 to a core is simplified. No adhesive has to be handled in the process of applying the surface layer 102 to a core.

The intermediate substrate 100 may be stored for a period of time, prior being included in a further process. The intermediate substrate 100 may be storable and/or stackable.

After the adhesive 201 has been applied to the surface layer 102, such that an intermediate substrate 100 is formed, a plurality of intermediate substrates 100 may be stacked on each other, as shown in FIG. 11. After the adhesive has solidified, and for some types of adhesives, crystallized, the substrates 100 can be stacked.

The intermediate substrates 100 may be stacked on each other without any intervening layers between adjacent intermediate substrates 100. The second surface 120 of the intermediate substrate 100 may contact the first surface 110 of an underlying intermediate substrate 100 without any intervening layer. The adhesive 201 applied on the first surface 110 of a first intermediate substate 100 may contact the surface of an underlying intermediate substrate 100 without any intervening layer. The surface of the underlying intermediate substrate 100 may be provided with an adhesive, such as two adhesive layers contact each other.

The intermediate substrates 100 may be stacked for a period of time. The intermediate substrates 100 may be stored in a stack for a period of time.

The intermediate substates 100 may be transported to another location for further processing. Such further processing may be application of the intermediate substates 100, in form of the surface layers 102, with the adhesive 201 applied on the intermediate substrate 100, on a core. Thereafter, the surface layer 102 is pressed to the core, with the adhesive 201 facing the core, to form a panel.

In the processes described above with reference to FIGS. 1-4, the core 1 and/or the surface layer 3 can be replaced by an intermediate substrate 100 as described above with reference to FIGS. 8-11. Thereby, the adhesive is already applied on the intermediate substrate 100. Consequently, the step of applying the adhesive can be removed from the processes described above with reference to FIGS. 1-4. The intermediate substrate 100 in form of the surface layer 102 may replace the surface layer 3. The intermediate substrate 100 in form of the core 101 may replace the core 1.

The intermediate substrate 101, 102 may have a width being equal or exceeding 0.5 m, for example in the range of 0.5-2.5 m. The intermediate substrate may have a length being equal or exceeding 1 m, for example in the range of 1-5.2 m.

If the intermediate substrate 100 is in form of the surface layer 102, the intermediate substrate may have a thickness equal or less than 0.5 mm, such as in the range of 0.2-0.5 mm.

If the intermediate substrate 100 is in form of the core 101, the intermediate substrate may have a thickness of 3-15 mm, such as 5-10 mm.

The intermediate substate 100 may be intended to form part of a building panel, such as such as a floor panel, a furniture component, a worktop, a wall panel, a ceiling panel.

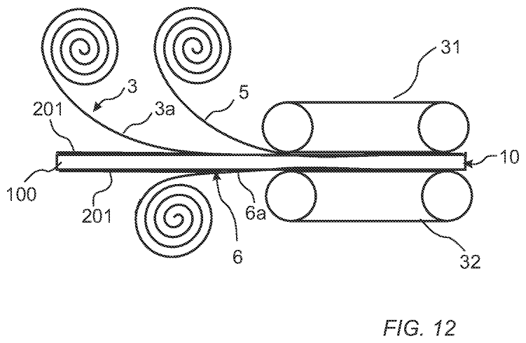

FIG. 12 shows a process to produce a panel 10 including the intermediate substrate 100 formed in a prior process. In the example shown in FIG. 12, the intermediate substrate 100 is a core 101, for example formed in a process as shown in FIG. 8. Prior to forming the panel 10, the intermediate substrate 100 may have been stored for a period of time, and/or transported to a different location.

In the example shown in FIG. 12, the intermediate substrate 100 is provided with the adhesive 201 on both the first surface 110 and on the second surface 120 of the intermediate substrate 100.

In the process shown in FIG. 12, a surface layer 3 comprising at least one resin impregnated paper 3a, 5 is applied on the first surface 110 of the intermediate substrate 100, provided with the adhesive 201. A first resin impregnated paper 3a may be a décor layer, such as being provided with a print. The second resin impregnated paper 5 may be an overlay paper, provided with abrasive resistant particles. The overlay may be substantially transparent. The first resin impregnated paper 3a is applied on the adhesive 201 on the first surface 110 of the intermediate substrate 100.

A balancing layer, in form of a third resin impregnated paper 6a, is applied to the adhesive 201 on the second surface 120 of the intermediate substrate 100.

The first, second and/or third resin impregnated paper may be impregnated with a thermosetting resin, such as an amino resin. The amino resin may be melamine formaldehyde, urea formaldehyde, or a co-polymer or combination thereof.

The thermosetting resin, such as the amino resin, may be substantially uncured. By substantially uncured is understood to mean in its A- or B-stage, for example, at least 90 wt % of the amino resin may be in the A- or B-state.

It is understood that the surface layer 3 may be of any type disclosed above with reference to FIGS. 1-4.

The surface layer 3 and the balancing layer 6 is thereafter pressed to the intermediate substrate 100 to form a panel 10. The pressing process may correspond to the pressing process described above with reference to FIGS. 1-4. The resulting panel 10 corresponds to the panel 10 disclosed in FIG. 5.

As discussed above, the intermediate substrate 100 may also be a surface layer 102. Such a surface layer 102 may be adhered to a core in a similar process as in FIG. 12, wherein the surface layer 102 is placed on the core with the adhesive 201 facing the core, and pressed to form a panel 10.

### EXAMPLE 1

Water resistant cores in form of SPC cores were provided. Hydrolysable hot melts adhesives according to the table below was applied to SPC cores. Melamine formaldehyde impregnated papers in form of a decorative paper and an overlay were applied on the hydrolysable adhesives and pressed at 20 bar and 175° C. for 45 seconds. Thereby, the melamine formaldehyde resin is crosslinked, simultaneously as the impregnated papers are adhered to the core. Appearance, climate stability, heat stability and adhesion (bond test) were visually tested according to the table below. Appearance was evaluated as lack of blister and/or other visual defects. Climate was tested by placing the samples in climate test chambers (90% relative humidity and 30% relative humidity) for 24 hours. Heat stability was tested by placing the samples in an oven at a temperature of 100° C. for 24 hours. Climate and heat stability were visually evaluated in view of decreased adhesion between layers and/or appearance.

| | | | | | Heat | Bond |
|---|---|---|---|---|---|---|
| Name | Polymer | Form | Appearance | Climate | stability | test |
| Gerlinger 4717 | Co-PES | Film | ok | ok | not ok | not |
| | | | | | | tested |
| Gerlinger 4630 | Co-PA | Film | ok | ok | ok | ok |
| Gerlinger 1154 | TPU | Film | ok | ok | ok | ok |
| Gerlinger 4461 | TPU | Film | Not ok | not | not | not |
| | | | | tested | tested | tested |
| Pearlbond 700 HMS, | TPU | Film | ok | ok | ok | ok |
| Lubrizol | | | | | | |
| Pearlbond 920, | TPU | Film | ok | ok | ok | ok |
| Lubrizol | | | | | | |
| Pearlbond 1160, | TPU | Film | Not ok | not | not | not |
| Lubrizol | | | | tested | tested | tested |
| Griltex 9E P82, EMS | Co-PES | Powder | ok | ok | ok | not |
| | | | | | | tested |
| Griltex 6E P82, EMS | Co-PES | Powder | ok | ok | ok | not |
| | | | | | | tested |
| Griltex 2A P82, EMS | Co-PA | Powder | ok | ok | ok | not |
| | | | | | | tested |
| Griltex D1500A, EMS | Co-PA | Powder | ok | ok | ok | not |
| | | | | | | tested |
| Opti-max 0821-80 500, | TPU | Powder | ok | ok | ok | not |
| CCS A/S | | | | | | tested |

### EXAMPLE 2

Hydrolysable hot melts adhesives according to the table below was applied to SPC cores. A powder mix comprising melamine formaldehyde resin and wood fibres was applied on the hot melt. A wood veneer layer was applied on the powder mix and pressed at 30 bar and 175° C. for 35 seconds. Thereby, the melamine formaldehyde resin is crosslinked, simultaneously as the wood veneer layer is adhered to the core. Appearance and adhesion (bond test) were visually tested according to the table below. Appearance was evaluated as lack of blister and/or other visual defects.

| Name | Polymer | Form | Appearance | Bond test |
|---|---|---|---|---|
| Pearlbond 700 | TPU | Film | ok | ok |
| HMS, Lubrizol | | | | |
| Opti-max | TPU | Powder | ok | ok |
| 0821-80 500, | | | | |
| CCS A/S | | | | |

### EXAMPLE 3

Hydrolysable hot melts adhesives according to the table below was applied to SPC cores. A powder mix comprising melamine formaldehyde, wood fibres and fibres was applied on the adhesive and pressed at 30 bar and 175° C. for 35 seconds. Thereby, the melamine formaldehyde resin is crosslinked, simultaneously as the powder mix layer is adhered to the core. Appearance and adhesion (bond test) were visually tested according to the table below. Appearance was evaluated as lack of blister and/or other visual defects.

| Name | Polymer | Form | Appearance | Bond test |
|---|---|---|---|---|
| Pearlbond 700 | TPU | Film | ok | ok |
| HMS, Lubrizol | | | | |
| Opti-max | TPU | Powder | ok | ok |
| 0821-80 500, | | | | |
| CCS A/S | | | | |

### EXAMPLE 4

Hydrolysable hot melts adhesives according to the table below was applied to SPC cores. A powder mix comprising melamine formaldehyde and wood fibres were applied on the adhesive. An overlay paper was applied to the powder mix and the assembly was pressed at 30 bar and 175° C. for 35 seconds. Thereby, the melamine formaldehyde resin is crosslinked, simultaneously as the powder mix layer and the overlay are adhered to the core. Appearance and adhesion (bond test) were visually tested according to the table below. Appearance was evaluated as lack of blister and/or other visual defects.

| Name | Polymer | Form | Appearance | Bond test |
|---|---|---|---|---|
| Pearlbond 700 | TPU | Film | ok | ok |
| HMS, Lubrizol | | | | |
| Opti-max | TPU | Powder | ok | ok |
| 0821-80 500, | | | | |
| CCS A/S | | | | |

### EXAMPLE 5

A hot melt adhesive, Opti-max 0821-80 500, CCS A/S, was applied in powder form to a SPC core in an amount of 100 g/m². The SPC core with the hot melt adhesive applied was placed in an oven during 1 hour at 150° C. Thereby, an intermediate substrate in form of the SPC core with pre-applied adhesive was formed. The core with the adhesive applied was stored during 24 hours prior to pressing.

Melamine formaldehyde impregnated papers in form of a decorative paper and an overlay were applied on the adhesive and the SPC core and impregnated papers were pressed at 30 bar and 185° C. for 35 seconds to form a panel.

### EXAMPLE 6

A hot melt adhesive, Pearlbond 700 HMS, Lubrizol, was applied as a film to a SPC core. The thickness of the film was approximately 100 μm, corresponding to an adhesive amount of 120 g/m². The SPC core with the hot melt adhesive applied was placed in an oven during 1 hour at 150° C. Thereby, an intermediate substrate in form of the SPC core with pre-applied adhesive was formed. The core with the adhesive applied was stored during 24 hours prior to pressing.

Melamine formaldehyde impregnated papers in form of a decorative paper and an overlay were applied on the adhesive and the SPC core and impregnated papers were pressed at 30 bar and 185° C. for 35 seconds to form a panel.

1. A method to produce a panel, comprising
providing a core having a first surface,
providing a surface layer comprising a substantially uncured amino resin,
applying an hydrolysable adhesive on the first surface of the core and/or on a surface of the surface layer adapted to face the core,
arranging the surface layer on the first surface of the core,
pressing the surface layer to the core to form a panel by applying heat and pressure in a press, thereby adhering the surface layer to the core by the hydrolysable adhesive and curing the amino resin of the surface layer.

2. The method according to claim 1, wherein the press has a temperature of at least 100° C., when pressure is released.

3. The method according to claim 1, wherein the press has a temperature of at least 100° C., when the panel is removed from the press.

4. The method according to claim 1, wherein pressing comprises applying heat of a temperature exceeding 100° C., when pressure is applied.

5. The method according to claim 1, wherein the step of pressing consists of a single press cycle.

6. The method according to claim 1, wherein pressing comprises applying pressure by means of at least one press plate or press belt, and wherein pressure is released in a heated state of said press plate or press belt.

7. The method according to claim 1, wherein pressing comprising applying a pressure of at least 10 bar and a temperature of at least 130° C. during a pressing time of at least 10 s.

8. The method according to claim 1, wherein the hydrolysable adhesive is a hydrolysable hot melt.

9. The method according to claim 1, wherein the hydrolysable adhesive comprises one or more of a group selected from:

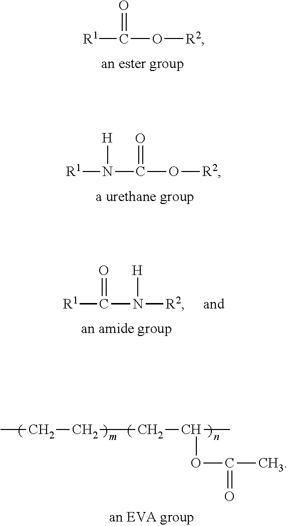

10. The method according to claim 1, wherein the amino resin is melamine formaldehyde, urea formaldehyde, or a combination or co-polymer thereof.

11. The method according to claim 1, wherein the hydrolysable adhesive is adapted to react with water at least partly resulting from a polycondensation reaction of said amino resin in a hydrolysis reaction.

12. The method according to claim 1, wherein the surface layer comprises at least one paper and said amino resin.

13. The method according to claim 1, wherein the surface layer is formed by applying the amino resin in powder or liquid form.

14. The method according to claim 1, wherein the surface layer comprises a wood veneer layer and the amino resin.

15. The method according to claim 1, wherein a binder of the core is a thermoplastic binder.

16. The method according to claim 1, wherein a binder of the core is an inorganic binder.

17. The method according to claim 1, wherein swelling of the core in thickness after immersion in water is less than 5% as measured according to EN317:1993, as measured according to EN317:1993.

18. A panel, comprising a core and a surface layer,
wherein the surface layer comprises an amino resin and is adhered to a first surface the core by a hydrolysable adhesive, and
wherein the core is a water resistant as defined by having a swelling in thickness after immersion in water being less than 5% as measured according to EN317:1993, as measured according to EN317:1993.

19. The panel according to claim 18, wherein the hydrolysable adhesive is a hydrolysable hot melt.

20. The panel according to claim 18, wherein the hydrolysable adhesive comprises one or more of a group selected from:

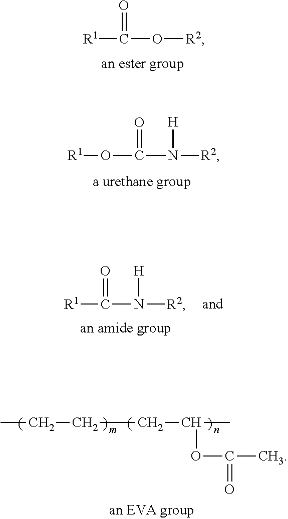

21. The method according to claim 18, wherein the amino resin is melamine formaldehyde, urea formaldehyde, or a combination or co-polymer thereof.

22. The method according to claim 18, wherein the surface layer comprises at least one paper and said amino resin.

23. The method according to claim 18, wherein the surface layer is formed by said amino resin and fillers.

24. The method according to claim 18, wherein the surface layer comprises a wood veneer layer and the amino resin.

25. The method according to claim 18, wherein a binder of the core is a thermoplastic binder.

26. The method according to claim 18, wherein a binder of the core is an inorganic binder.

27. A method of forming an intermediate substrate, comprising
providing a substrate having a first surface,
applying a hydrolysable adhesive on the first surface of the substrate,
storing the substrate with the adhesive applied on the first surface of the substrate prior to adhering the substrate to a surface layer or to a core.

28. The method according to claim 27, further comprising stacking a plurality of said substrates when the adhesive has solidified, without any intervening layers between adjacent substrates.

29. The method according to claim 27, wherein the substrate comprises at least one paper layer and an amino resin.

30. The method according to claim 27, wherein the substrate comprises an amino resin and fillers.

31. The method according to claim 27, wherein the substrate comprises a wood veneer layer and an amino resin.

32. The method according to claim 29, wherein the amino resin is substantially uncured.

33. The method according to claim 32, wherein the hydrolysable adhesive is adapted to react with water at least partly resulting from a polycondensation reaction of said amino resin in a hydrolysis reaction.

34. The method according to claim 27, wherein the substrate is a water-resistant substrate as defined by swelling in thickness after immersion in water being less than 5% as measured according to EN317:1993.

35. The method according to claim 34, wherein providing the substrate comprises forming the substrate by a pressing or extrusion process, and wherein the adhesive is applied to the substrate prior to cooling the substrate after pressing or extrusion.

36. The method according to claim 34, wherein a binder of the substrate is a thermoplastic binder.

37. The method according to claim 34, wherein a binder of the substrate is an inorganic binder.

38. The method according to claim 29, 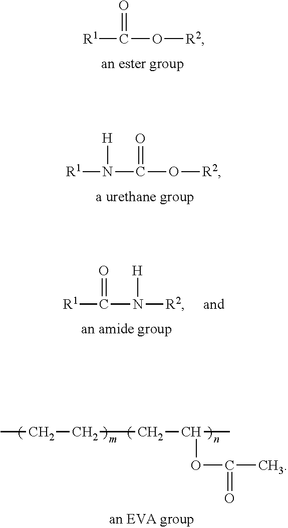
wherein the hydrolysable adhesive comprises one or more of a group selected from:

39. The method according to claim 27, wherein a width of the substrate is equal to or exceeds 0.5 m, and a length of the substrate is equal to or exceeds 1 m.

40. The method according to claim 27, wherein a thickness of the substrate is equal to or less than 0.5 mm.

41. The method according to claim 27, wherein a thickness of the substrate is 3-15 mm.

42. A method to produce a panel, comprising
providing an intermediate substrate according to claim 27,
applying a core or a surface layer to the first surface of the intermediate substrate,
pressing the intermediate substrate to the core or to the surface layer to form a panel by applying heat and pressure in a press, thereby adhering the intermediate substrate to the core or to the surface layer by the adhesive.
